(19) United States
(12) Patent Application Publication
(10) Pub. No.: US 2017/0246831 A1
(43) Pub. Date: Aug. 31, 2017

(54) PLASTIC FABRIC USING DIFFERENT-MELTING POINT CORE-SHEATH STRUCTURE FIBER

(71) Applicant: Long John Tsung Right Industrial Co., Ltd., Chang-Hwa County (TW)

(72) Inventors: Wen-Tsao WEN, Chang-Hwa County (TW); Yu-Chang WEN, Changhua County (TW)

(21) Appl. No.: 15/056,173

(22) Filed: Feb. 29, 2016

(51) Int. Cl. B32B 5/02; D04B 39/00; D03D 1/00; D04B 31/02

(52) U.S. Cl. CPC B32B 5/02; D04B 31/02; D04B 39/00; D03D 1/00; D10B 2501/02; D10B 2331/04; B32B 2437/02; B32B 2437/00

(57) ABSTRACT

A plastic fabric using a different-melting point core-sheath structure fiber comprises a top layer fabric, a support layer, and a bottom layer fabric. The top layer fabric is fabricated with a different-melting point fiber, which comprises a core-sheath structure including a core and a sheath wrapping the core. The core has a melting point higher than that of the sheath. The bottom layer fabric is disposed on one side of the top layer fabric. The support layer is disposed between the top layer fabric and the bottom layer fabric. As the core has a melting point higher than that of the sheath, the different-melting point fiber has superior dimensional stability and permanent shape memory after heat treatment for plastic shaping.

### FIELD OF THE INVENTION

The present invention relates to a plastic fabric, particularly to a plastic fabric using a different-melting point core-sheath structure fiber and having superior plasticity.

### BACKGROUND OF THE INVENTION

Plastic fabrics are widely applied to various functional costumes. For example, a U.S. Pat. No. 8,439,721 disclosed a support sports underwear, which comprises a first layer and a second layer both made of a compressible material. The first layer has at least one support trench that is incompletely filled. The support trench encircles at least a portion of the breast of the wearer. The first layer also has an outer layer. The second layer has a pair of mold-shaped cups. The first layer and the second layer are integrated with each other. The support sports underwear is mainly made of thermoplastic polyurethane (TPU). The support sports underwear may be made of a material disclosed in U.S. Pat. Nos. 8,162,718 and 7,618,304.

The conventional technology for fabricating thermoplastic fabrics normally adopts a soaking method or a coating method. However, both methods are likely to cause stiffness, poor air permeability and inferior plasticity, which are unfavorable for application to costumes. In some applications, the fabric needs high supporting capability because the fabric is to be shaped into a curved surface. However, the abovementioned factors are unfavorable to achieve the objective.

### SUMMARY OF THE INVENTION

The primary objective of the present invention is to solve the problem that the conventional plastic fabric has inferior plasticity.

In order to achieve the abovementioned objective, the present invention proposes a plastic fabric using a different-melting point core-sheath structure fiber, which comprises a top layer fabric; a bottom layer fabric disposed on one side of the top layer fabric; and a support layer disposed between the top layer fabric and the bottom layer fabric. The top layer fabric is fabricated with a different-melting point fiber. The different-melting point fiber comprises a core-sheath structure, which includes a core and a sheath wrapping the core. The core has a melting point higher than that of the sheath.

While the different-melting point fiber is heated for plastic shaping, the sheaths having a lower melting point melt beforehand and stick to each other, and then the cores melt and stick to each other. During cooling down, the cores solidify beforehand, and then the sheaths solidify. Therefore, the different-melting point fiber has superior dimensional stability and permanent shape memory, particularly suitable to be the material of shoes requiring a given curvature or curved significantly. Compared to the shoes fabricated with the conventional material, the shoes fabricated with the present invention is exempted from auxiliary plates, uses less material and has lower fabrication cost.

### BRIEF DESCRIPTION OF THE DRAWINGS

FIG. 1 is a perspective view schematically showing a plastic fabric using a different-melting point core-sheath structure fiber according to one embodiment of the present invention;

FIG. 2 is a sectional view schematically showing a plastic fabric using a different-melting point core-sheath structure fiber according to one embodiment of the present invention;

FIG. 3 is a sectional view schematically showing a different-melting point fiber according to one embodiment of the present invention;

FIG. 4 is a diagram schematically showing an application to a female sports underwear according to one embodiment of the present invention; and

FIG. 5 is a diagram schematically showing an application to a shoe according to one embodiment of the present invention.

### DETAILED DESCRIPTION OF THE PREFERRED EMBODIMENTS

The technical contents of the present invention will be described in detail in cooperation with drawings below.

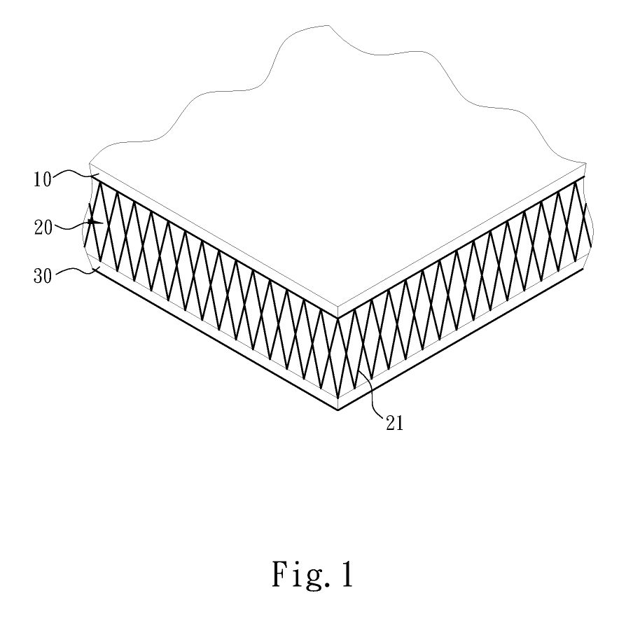

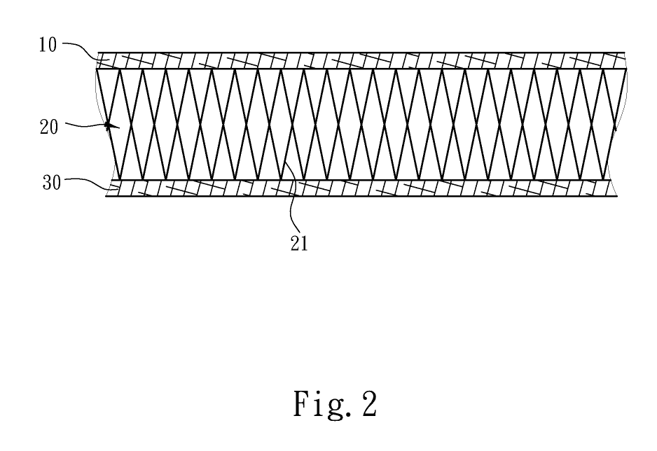

Refer to FIG. 1 and FIG. 2 respectively a perspective view and a sectional view schematically showing a plastic fabric using a different-melting point core-sheath structure fiber according to one embodiment of the present invention. The plastic fabric using a different-melting point core-sheath structure fiber of the present invention comprises a top layer fabric 10, a support layer 20 and a bottom layer fabric 30. The bottom layer fabric 30 is disposed opposite the top layer fabric 10. The support layer 20 is disposed between the top layer fabric 10 and the bottom layer fabric 30.

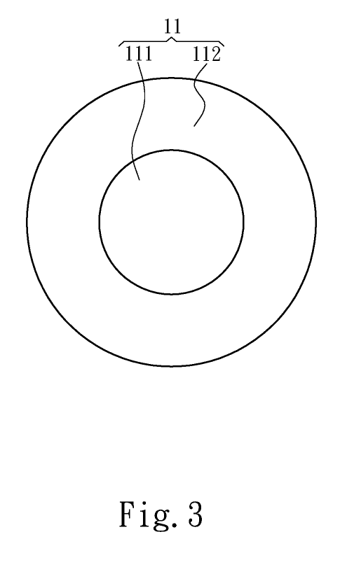

Refer to FIG. 3 a sectional view schematically showing a different-melting point fiber according to one embodiment of the present invention. The top layer fabric 10 is fabricated with a different-melting point fiber 11. The different-melting point fiber 11 comprises a core-sheath structure including a core 111 and a sheath 112 wrapping the core 111. In the present invention, the core 111 has a melting point higher than that of the sheath 112. In detail, the sheath 112 has a first melting point, and the core 111 has a second melting; the second melting point is higher than the first melting point. In one embodiment, the first melting point ranges from 170 to 210° C.; the second melting point ranges from 230 to 270° C.; the softening point of the core 111 and the sheath 112 ranges between 70 to 80° C. In one embodiment, the core 111 and the sheath 112 are made of polyethylene terephthalate (PET).

As shown in FIG. 2, the support layer 20 includes a plurality of support segments 21 each including two ends respectively connected with the top layer fabric 10 and the bottom layer fabric 30. The support segments 21 intersect mutually by an angle ranging from 10 to 90 degrees. The support segment 21 is a mono-filament fiber, such as a polyester fiber, a polypropylene (PP) fiber, a polyamide fiber, a polyethylene (PE) fiber, a polyacrylonitrile (PAN) fiber, or a polyethylene terephthalate (PET) fiber. In one embodiment, the support segments 21 are joined with the top layer fabric 10 and the bottom layer fabric 30 in a hooking way.

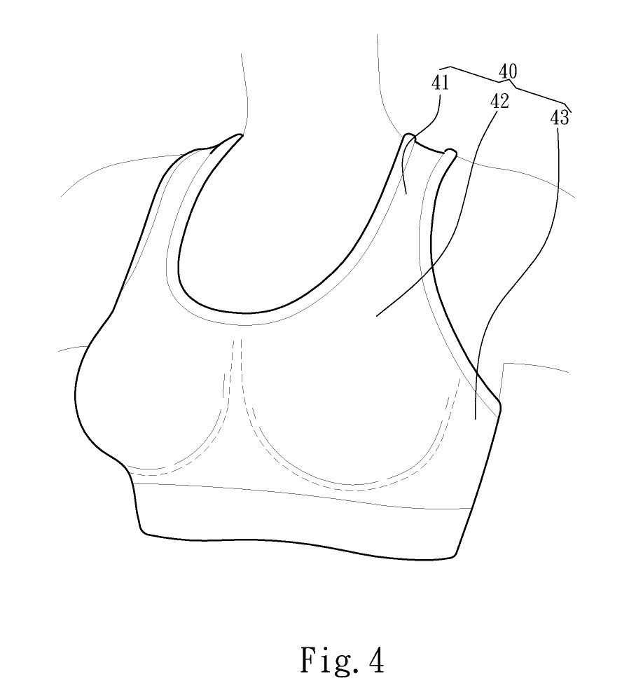

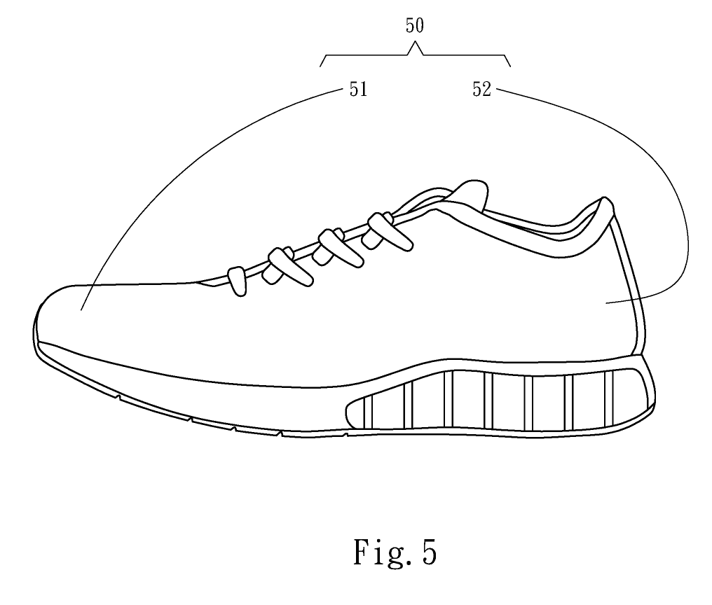

In the present invention, the top layer fabric 10 and the bottom layer fabric 30 can be fabricated in a weaving method, a knitting method or a crocheting method. In one embodiment, the top layer fabric 10 and the bottom layer fabric 30 are fabricated with a circular knitting machine and respectively woven along the longitudinal direction and the latitudinal direction to separately provide the top layer fabric 10 and the bottom layer fabric 30 with extensibility in vertical directions. The bottom layer fabric 30 may adopt an elastic fiber used in the field as the yarn thereof, preferably an elastic fiber selected from a group including the Spandex fiber, the Nylon 6 fiber, the Nylon 6-6 fiber, the polyethylene terephthalate (PET) fiber, the polyurethane (PU) fiber, the polyethylene (PE) fiber, the polypropylene (PP) fiber, and the combinations thereof. Refer to FIG. 4 a diagram schematically showing an application to a female sports underwear 40 according to one embodiment of the present invention. In the embodiment, the female sports underwear 40 comprises two should straps 41, two cups 42 and a chest band 43. As the plastic fabric using a different-melting point core-sheath structure fiber of the present invention has superior dimensional stability, it is suitable to be the material of the cups 42. Refer to FIG. 5 a diagram schematically showing an application to a shoe 50 according to one embodiment of the present invention. The plastic fabric of the present invention can be applied to a shoe 50. The shoe 50 comprises a toe cap 51 and a shoe heel 52. In the conventional technology, a hard auxiliary plate (also called the “GanBau plate” or the “hot-melt glue plate” colloquially) is embedded in the toe cap 51 or the shoe heel 52 to form the shoe 50 into the expected shape and make the shoe 50 fit to the foot. As the plastic fabric of the present invention has superior dimensional stability and plasticity, the toe cap 51 or the shoe heel 52 using the plastic fabric of the present invention is exempted from using the auxiliary plate. In one embodiment, the plastic fabric of the present invention is applied to the shoe 50; the top layer fabric 10 uses the different-melting point fiber 11, and the bottom layer fabric 30 uses a PET fiber; the plastic fabric is hot-pressed at a temperature of 140-190° C. to form the toe cap 51 and the shoe heel 52.

In summary, the present invention fabricates a plastic fabric with a different-melting point fiber comprising a core-sheath structure whose core has a melting point higher than that of the sheath. During heating, the sheaths melt beforehand and stick to each other, and then the cores melt and stick to each other. During cooling down, the cores solidify beforehand and then the sheaths solidify. Owing to the abovementioned characteristics, the different-melting point fiber has superior dimensional stability and permanent shape memory after heat treatment for plastic shaping, particularly suitable to be the material of shoes requiring a given curvature or curved significantly. Compared to the shoes fabricated with the conventional material, the shoes fabricated with the present invention are exempted from auxiliary plates, use less material and have lower fabrication cost.

What is claimed is:

1. A plastic fabric using a different-melting point core-sheath structure fiber, comprising
a top layer fabric fabricated with a different-melting point fiber, which comprises a core-sheath structure including a core and a sheath wrapping the core, wherein the core has a melting point higher than that of the sheath;
a bottom layer fabric disposed on one side of the top layer fabric; and
a support layer disposed between the top layer fabric and the bottom layer fabric.

2. The plastic fabric using a different-melting point core-sheath structure fiber according to claim 1, wherein the core and the sheath are made of polyethylene terephthalate (PET).

3. The plastic fabric using a different-melting point core-sheath structure fiber according to claim 1, wherein the bottom layer fabric is made of a fiber selected from a group including a Spandex fiber, a Nylon 6 fiber, a Nylon 6-6 fiber, a polyethylene terephthalate (PET) fiber, a polyurethane (PU) fiber, a polyethylene (PE) fiber, a polypropylene (PP) fiber, and combinations thereof.

4. The plastic fabric using a different-melting point core-sheath structure fiber according to claim 1, wherein the top layer fabric and the bottom layer fabric are fabricated in a weaving method, a knitting method or a crocheting method.

5. The plastic fabric using a different-melting point core-sheath structure fiber according to claim 1, wherein the support layer includes a plurality of support segments each including two ends respectively connected with the top layer fabric and the bottom layer fabric.

6. The plastic fabric using a different-melting point core-sheath structure fiber according to claim 5, wherein the support segments intersect mutually by an angle ranging from 10 to 90 degrees.

7. The plastic fabric using a different-melting point core-sheath structure fiber according to claim 5, wherein the support segment is a mono-filament fiber selected from a group including a polyester fiber, a polypropylene (PP) fiber, a polyamide fiber, a polyethylene (PE) fiber, a polyacrylonitrile (PAN) fiber, or a polyethylene terephthalate (PET) fiber.

8. The plastic fabric using a different-melting point core-sheath structure fiber according to claim 1, wherein the sheath has a first melting point, and the core has a second melting higher than the first melting point.

9. The plastic fabric using a different-melting point core-sheath structure fiber according to claim 8, wherein the first melting point ranges from 170 to 210° C.

10. The plastic fabric using a different-melting point core-sheath structure fiber according to claim 8, wherein the second melting point ranges from 230 to 270° C.
